(19) United States
(12) Patent Application Publication
(10) Pub. No.: US 2018/0115581 A1
(43) Pub. Date: Apr. 26, 2018

(54) SOFTWARE DEFINED NETWORK FOR PREVENTING AN ATTACK ON A HOST TRACKING SERVICE AND CONTROLLER INCLUDED IN THE SAME

(71) Applicant: FOUNDATION OF SOONGSIL UNIVERSITY INDUSTRY COOPERATION, Seoul (KR)

(72) Inventors: Myungsik YOO, Seoul (KR); Tri Hai NGUYEN, Seoul (KR); Jin Seok CHOI, Seoul (KR)

(21) Appl. No.: 15/692,194

(22) Filed: Aug. 31, 2017

(30) Foreign Application Priority Data
Oct. 25, 2016 (KR) 10-2016-0139066

(51) Int. Cl. H04L 29/06

(52) U.S. Cl. CPC H04L 63/1458; H04L 43/16; H04L 63/1425; H04L 63/1416

(57) ABSTRACT

Software defined network (SDN) for preventing an attack on a host tracking service and a controller included in the same are disclosed. The SDN comprises a plurality of switches arranged on a data plane of the SDN, and connected to at least one host, and a controller arranged on a control plane of the SDN, configured to control the switches and perform a host tracking service for recognizing location of at least one host connected to the switches. Here, a switch A of the switches receives a packet from a host A connected to the switch A and transmits an address information message of the host A to the controller based on the packet. The controller determines whether or not the host A is a host for performing an attack on the host tracking service, by using the address information message and previous address information of the host.

### PRIORITY

This application claims priority under 35 U.S.C. § 119(a) to a Korean patent application filed on Oct. 25, 2016 in the Korean Intellectual Property Office and assigned Serial No. 10-2016-0139066, the entire disclosure of which is incorporated herein by reference.

### TECHNICAL FIELD

The present disclosure relates to a software defined network SDN for preventing an attack on a host tracking service and a controller included in the same.

### BACKGROUND ART

Internet plays inseparably an important role in our daily life, and it is predicted that role of Internet increases when internet of thing IoT is really applied to daily life. However, conventional network equipment operates according to a preset rule, and thus it is difficult to manage it and it is inconvenient that every related equipment must be updated or exchanged when new function is added. It seems that the network equipment is weak to various new malicious attacks in security.

Accordingly, a software defined network SDN has been developed to solve the above problem. Unlike the conventional network equipment, a control plane and a data plane are divided in the SDN. As a result, network architecture is simple, the network is flexibly managed, and the network is partially stronger to malicious attacks than the conventional network. However, the SDN does not provide perfect solution in security and it has still weakness in security.

A host tracking service HTS may recognize or track location of every host in the SDN. However, since the HTS does not require validation check, authentication or authorization, an attacker can perform an attack by transmitting a malicious message through a switch controlled by a controller in the SDN. That is, the attacker may pretend to be easily a target host so that the HTS can misrecognize location of a host. This may induce serious hijacking, and arouse denial of service or a man-in-the-middle attack.

### SUMMARY

Accordingly, the invention is provided to substantially obviate one or more problems due to limitations and disadvantages of the related art. One embodiment of the invention provides an SDN for preventing an attack on a host tracking service and a controller included in the same.

Other features of the invention may be thought by a person in an art through following embodiments.

In one embodiment, the invention provides a software defined network comprising: a plurality of switches arranged on a data plane of the software defined network, and connected to at least one host; and a controller arranged on a control plane of the software defined network, configured to control the switches and perform a host tracking service for recognizing location of at least one host connected to the switches. Here, a switch A of the switches receives a packet from a host A connected to the switch A and transmits an address information message of the host A to the controller based on the packet, and the controller determines whether or not the host A is a host for performing an attack on the host tracking service, by using the address information message and previous address information of the host A stored in the controller.

The received address information message may include at least one of IP address of the host A and port address of the switch A connected to the host A, and the controller stores a host profile. Here, the host profile includes at least one of IP address of each of the hosts connected to the switches and port address of a switch connected to the host.

The controller may transmit a check message to a switch B connected to a host B when the host B having the same IP address as the host A included in the address information message is stored in the host profile, and determine that the host A pretends to be the host B when an ACK message corresponding to the check message is received from the host B through the switch B.

The check message may be a message for determining availability of the host B.

In one embodiment, the invention provides a controller arranged on a control plane of a software defined network including the control plane and a data plane and for performing a host tracking service, the controller comprising: a port manager configured to receive an address information message of a host A connected to a switch A from the switch A of plural switches which are arranged on the data plane and connected to at least on host, extract IP address of the host A in the address information message and port address of the host A for the switch A, and search port address of a switch B connected to a host B when the host B having the same IP address as the host A is stored in a host profile, a host probing configured to transmit a check message to the switch B connected to the host B; and a host checker configured to determine that the host A pretends to be the host B, when an ACK message corresponding to the check message is received from the host B through the switch B.

The software defined network of the invention may prevent an attack on a host tracking service performed by a controller.

### BRIEF DESCRIPTION OF DRAWINGS

Example embodiments of the present invention will become more apparent by describing in detail example embodiments of the present invention with reference to the accompanying drawings, in which:

FIG. 1 is a view illustrating a basic architecture of SDN;

FIG. 2 is a view illustrating OpenFlow used in SDN;

FIG. 3 is a view illustrating coarse structure of an SDN according to one embodiment of the invention;

FIG. 4 is a view illustrating an example of an attack on a host tracking service;

FIG. 5 is a block diagram illustrating the controller according to one embodiment of the invention; and

FIG. 6 is a flowchart illustrating an operation of the controller for preventing the attack on the host tracking service according to one embodiment of the invention.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

Hereinafter, a software defined network SDN of the invention will be briefly described.

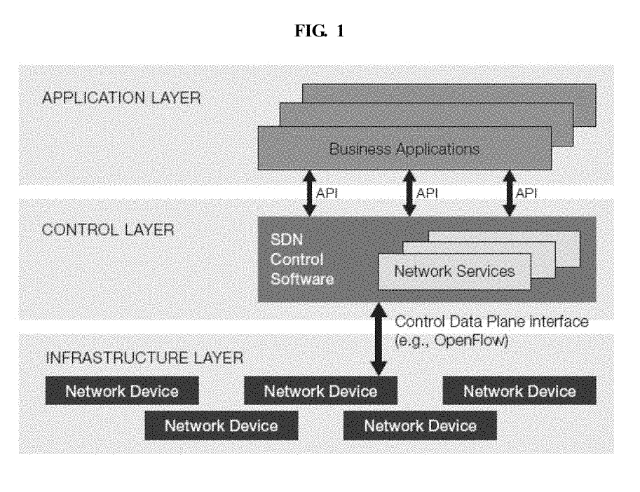

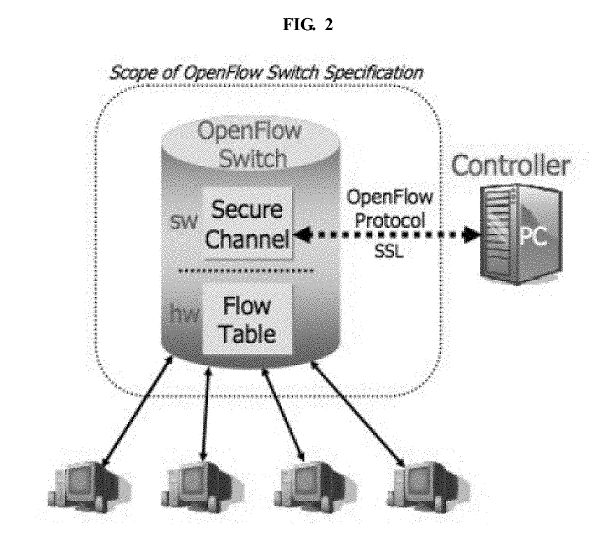

FIG. 1 is a view illustrating a basic architecture of SDN, and FIG. 2 is a view illustrating OpenFlow used in SDN.

In FIG. 1, layers of the SDN are divided into an infrastructure layer corresponding to a data plane, a control layer corresponding to a control plane and an application layer. The data layer is controlled through a specific interface of the SDN, and it is in charge of data transmission. The control layer controls flowing of data, and it determines whether it routes, delivers or rejects the flowing of data through an application and a network service. Additionally, the control layer organizes operations of the data layer and delivers the organization to the application layer in type of an application programming interface API. The application layer may perform various functions of a network by using APIs provided from the control layer.

In traditional network, network equipments such as a router or a switch take charge of traffic control and a rule. Hence, router information of the network is stored in the switch and the router. This network architecture has the problem in that a manager arranges related internet equipments whenever the network is changed and a data center or a group network environment wastes resources due to frequent network changing.

An OpenFlow is a technique, used as an interface standard between the controller and the network equipment, for supplementing the above problem of the traditional network. Referring to FIG. 2, the OpenFlow may manage the network under dividing the control plane and the data plane, thereby separating a function of controlling network traffic and a function of delivering data and controlling the network by using built software. If an OpenFlow protocol is used, the control plane and the data plane may be made with software not hardware. Furthermore, new function may be rapidly realized by installing the software to a general server.

The OpenFlow may generate one information by combining header information of protocol layer 1 to protocol layer 4 and designate operation of a packet (frame) by using the one information. If a program of the control plane is amended, a user may generate freely new protocol in the range of the protocol layer 1 to the protocol layer 4 and achieve a network optimized to a specific service or application. That is, the OpenFlow divides the function of controlling the packet and the function of delivering the packet and controls the network via the programming.

The SDN for preventing an attack on a host tracking service according to one embodiment of the invention will be described in detail.

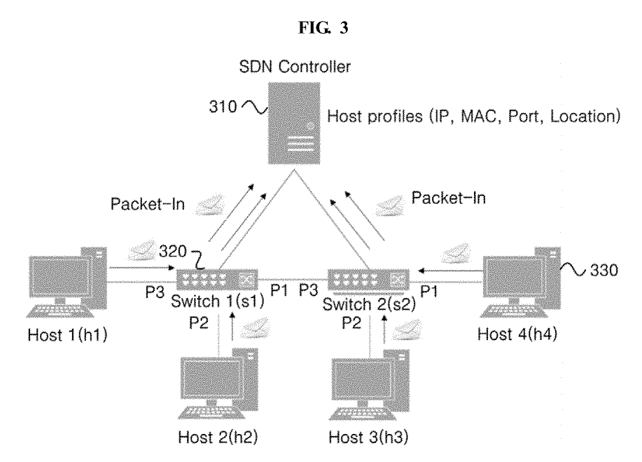

FIG. 3 is a view illustrating coarse structure of an SDN according to one embodiment of the invention.

In FIG. 3, the SDN 300 of the present embodiment includes a controller 310, plural switches 320 and a plurality of hosts 330.

The controller 310, i.e. SDN controller is arranged on a control plane, and performs every control instruction of the network and delivering of data traffic, and controls directly whole network.

Each of the switches 320 is arranged on the data plane, and its operation is controlled by the controller 310. That is, the controller 310 transmits instructions to each of the switches 320. Each of the switches 320 transmits packets to a destination, amends or discards the packets according to a received instruction. For example, the controller 310 delivers a forwarding method of the packet or a priority value of a VLAN, etc. to the switch 320 by using OpenFlow protocol so that the switch 320 operates according to the delivered forwarding method or the priority value. The switch 320 inquires error information and information concerning a packet not corresponding to a pre-registered flow entry to the controller, receives determination of the controller in accordance with the inquiring and processes the packet in response to the determination.

Specially, the controller 310 performs path computation as a main function, and determines a path based on several parameters when the packet is transmitted. The parameters include weight of a path designated by the user or load distribution condition, etc. as well as shortest path SPF or line speed. Path information computed by the controller 310 is transmitted to the switch 320 via transport layer security TLS or general TCP connection and then it is stored in a flow table. Subsequently, the switch 320 verifies the flow table whenever it receives the packet and transmits corresponding frame through a designated path.

The hosts 330 are connected to the switches, respectively. Here, the host 330 may have address information, and transmit or receive packets through the address information. In one embodiment, the address information of the host 330 may include IP address, MAC address and port address of a switch connected to the host and so on.

The controller 310 may perform a host tracking service HTS which can recognize or track location of every host in the SDN 300. Brief description concerning this operation is follows.

In the SDN 300, the host 330 may perform migration between different physical locations of the network. The host tracking service performed by the controller 310 may track the location of the host 330. The host tracking service provides a method of probing dynamically packet-in-messages and updating host profiles, to assure flexibly mobility of the network. Here, the host profile is stored in the controller 310, and includes IP address, MAC address, Datapath ID DPID of every host 330, port number of a switch 320 connected to each of the host 330 and final timestamp, etc. The host tracking service processes a JOIN event and a MOVE event which are two related host events.

In this time, since the host tracking service does not require the validation check, authentication or authorization as described above, the attacker may execute the attack by transmitting the malicious message through the switch 320 controlled by the controller 310 in the SDN.

Hereinafter, example of the attack on the host tracking service will be described.

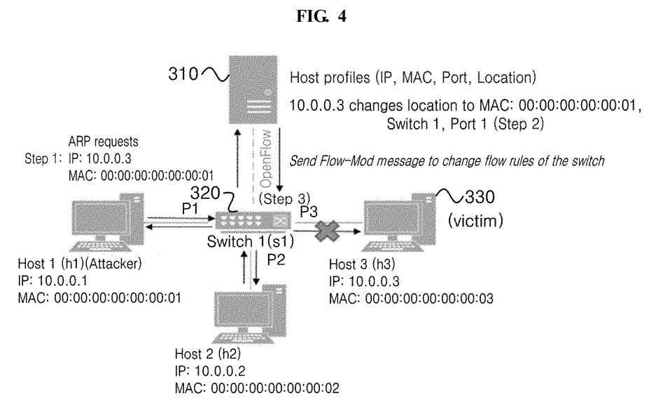

Referring to FIG. 4, three hosts 330 are connected to one switch 320. The host 1 is a host of the attacker, and the host 3 is a host of a user attacked by the attacker. It is assumed that the host 1 pretends to be the host 3. The attack on the host tracking service is performed in following three steps.

In a step 1, the host 1 as the attacker pretends IP address of the host 3 and transmits false ARP request to the switch 320. The switch 320 transmits the false ARP to the controller 310. Here, real address information of the host 1 is [IP: 10.0.0.1, MAC: 00:00:00:00:00:00:01], and real address information of the host 3 is [IP: 10.0.0.3, MAC: 00:00:00:00:00:00:03]. Address information of the host 1 is [IP: 10.0.0.3, MAC: 00:00:00:00:00:00:01], in view of the controller 310.

In a step 2, the controller 310 obtains the above information, and changes the IP address of the host 1 from [10.0.0.1] to [10.0.0.3]. The controller 310 transmits a message for controlling the switch 320.

In a step 3, the user is connected to the host 1 not the host 3. As a result, the host 1 may intercept traffic transmitted to the host 3.

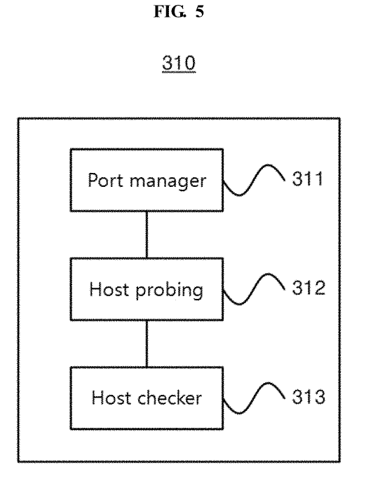

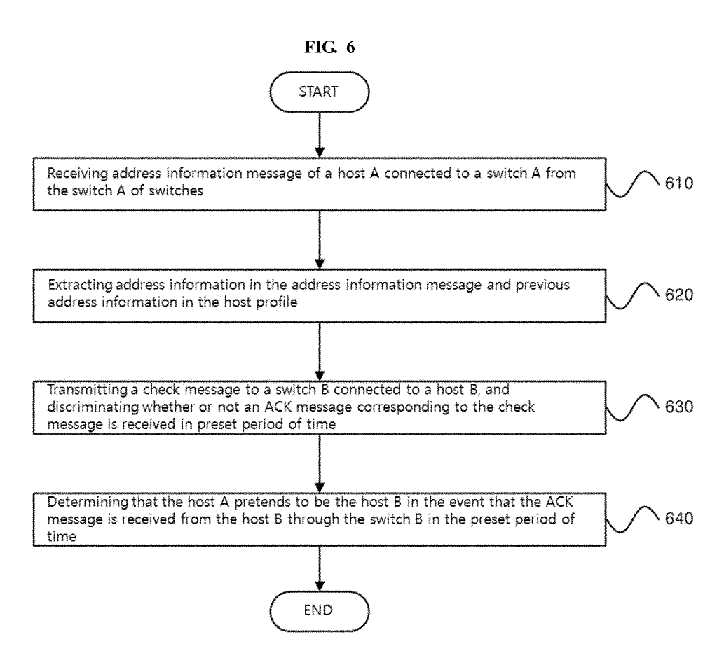

FIG. 5 is a block diagram illustrating the controller according to one embodiment of the invention. In FIG. 5, the controller 310 of the present embodiment includes a port manager 311, a host probing 312 and a host checker 313. FIG. 6 is a flowchart illustrating an operation of the controller for preventing the attack on the host tracking service according to one embodiment of the invention.

Hereinafter, the SDN 300 capable of preventing the attack on the host tracking service and the controller 320 will be described in detail with reference to drawings FIG. 3, FIG. 5 and FIG. 6.

In a step of 610, the port manager 311 receives an address information message of a host A connected to a switch A from the switch A of switches.

That is, the host A is connected to the switch A. The host A transmits packets to the switch A. The switch A generates the address information message of the host A, i.e. packet-in message based on the received packets and transmits the generated address information message to the controller 310.

Here, the address information message may include at least one of IP address of the host A, MAC address of the host A or port address of the switch A connected to the host A. On the other hand, the host profile may be stored as described above, and it may include Datapath ID DPID, port number of the switch 320 connected to each of the hosts 330, a final timestamp, etc.

In a step of 620, the port manager 311 extracts address information in the address information message and previous address information stored in the host profile.

That is, the port manager 311 extracts IP address of the host A in the address information message and the port address of the host A for the switch A, and searches port address of a switch B connected to a host B when the host B having the same IP address as the host A is stored in the host profile.

In a step of 630, the host probing 312 transmits a check message to the switch B connected to the host B, and discriminates whether or not it receives an acknowledge (ACK) message corresponding to the check message in a preset period of time.

That is, the host probing 312 transmits the check message to address of the host B which is previous address information of the host A, and discriminates whether or not the ACK message is received from the host B. The check message may be a message for determining availability of the host B (whether it perform any operation under it is connected to the network), for example ICMP Echo Request.

In a step of 640, the host checker 313 determines that the host A pretends to be the host B in the event that the ACK message is received from the host B through the switch B in the preset period of time.

In the event that the ACK message is not received in the preset period of time, the host B may be a host of which connection is cut off in the SDN 300. Accordingly, the host B may be the same host as the host A (for example, the host B migrates to location of the host A). In this case, the attack on the host tracking service may not be performed.

In the event that the ACK message is received in the preset period of time, the host B is a connected host in the SDN 300. As a result, two hosts (host A, host B) having the same IP address exist on the SDN 300. Accordingly, the host B located on previous address may be a right host, and the host A located on new address may be a host of the attacker. Hence, the controller 310 may block connection to the malicious host A in the SDN 300, and thus prevent the attack on the host tracking service.

Briefly, the controller 310 of the invention may determine whether or not a specific host is a host for performing the attack on the host tracking system, by using address information message received from the specific host and previous address information of the host stored in the controller 310.

Components in the embodiments described above can be easily understood from the perspective of processes. That is, each component can also be understood as an individual process. Likewise, processes in the embodiments described above can be easily understood from the perspective of components. The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

1. A software defined network comprising:
a plurality of switches arranged on a data plane of the software defined network, and connected to at least one host; and
a controller arranged on a control plane of the software defined network, configured to control the switches and perform a host tracking service for recognizing location of at least one host connected to the switches,
wherein a switch A of the switches receives a packet from a host A connected to the switch A and transmits an address information message of the host A to the controller based on the packet, and
the controller determines whether or not the host A is a host for performing an attack on the host tracking service, by using the address information message and previous address information of the host A stored in the controller.

2. The software defined network of claim 1, wherein the received address information message includes at least one of IP address of the host A and port address of the switch A connected to the host A, and
the controller stores a host profile,
and wherein the host profile includes at least one of IP address of each of the hosts connected to the switches and port address of a switch connected to the host.

3. The software defined network of claim 2, wherein the controller transmits a check message to a switch B connected to a host B when the host B having the same IP address as the host A included in the address information message is stored in the host profile, and determines that the host A pretends to be the host B when an ACK message corresponding to the check message is received from the host B through the switch B.

4. The software defined network of claim 3, wherein the check message is a message for determining availability of the host B.

5. A controller arranged on a control plane of a software defined network including the control plane and a data plane and for performing a host tracking service, the controller comprising:
a port manager configured to receive an address information message of a host A connected to a switch A from the switch A of plural switches which are arranged on the data plane and connected to at least on host, extract IP address of the host A in the address information message and port address of the host A for the switch A, and search port address of a switch B connected to a host B when the host B having the same IP address as the host A is stored in a host profile,
a host probing configured to transmit a check message to the switch B connected to the host B; and
a host checker configured to determine that the host A pretends to be the host B, when an ACK message corresponding to the check message is received from the host B through the switch B.
